(19) United States
(12) Patent Application Publication
(10) Pub. No.: US 2015/0208590 A1
(43) Pub. Date: Jul. 30, 2015

(54) METHOD FOR STIMULATING PLANT GROWTH, APPARATUS AND METHODS FOR COMPUTING CUMULATIVE LIGHT QUANTITY

(71) Applicant: YEN-DONG WU, Tainan City (TW)

(72) Inventor: Yen-Dong Wu, Tainan City (TW)

(73) Assignee: YEN-DONG WU, TAINAN CITY, TW (TW)

(21) Appl. No.: 14/415,134

(22) PCT Filed: Jul. 17, 2013
(86) PCT No.: PCT/US2013/050860

§ 371 Date: Jan. 15, 2015

(30) Foreign Application Priority Data
Jul. 18, 2012 (TW) 101125941

(51) Int. Cl. A01G 7/04; G02B 26/00

(52) U.S. Cl. CPC A01G 7/045; G02B 26/007

(57) ABSTRACT

The present invention provides a method for stimulating plant growth, which comprises: (a) placing a light transmissive material for adjusting or retaining light spectrum wavelengths below 500 nm (section A), between 500˜630 nm (section B), and above 630 nm (section C) between the light and a photosynthesis receptor of the plant; and (b) providing the illuminance or photon flux density of section B lower than that of section A or section C after the light passing through the light transmissive material. The present invention also provides an apparatus and methods for computing cumulative light quantity, comprising (a) a spectrum sensing unit; (b) a spectrum multi-band setting module; (c) a cumulative light quantity computing module; (d) an information processing unit; and (e) a control unit.

### CROSS-REFERENCES TO RELATED APPLICATIONS

The application is the national stage of PCT international Application Number PCT/US2013/050860 filed on Jul. 17, 2013. The present invention also claims priority to TW Patent Application No. 101125941 filed on Jul. 18, 2012, incorporated herein by reference in its entirety.

### FIELD OF THE INVENTION

The present invention relates to a method for stimulating plant growth. The present invention also relates to an apparatus and methods for computing cumulative light quantity.

### BACKGROUND OF THE INVENTION

Photosynthesis is a process used by plants and other autotrophic organisms to convert light energy, normally from the sun, into chemical energy that can be used to fuel the organisms' activities. Carbohydrates, such as sugars, are synthesized from carbon dioxide and water during the process. Oxygen is also released, mostly as a waste product. Most plants, most algae, and cyanobacteria perform the process of photosynthesis, and are called photoautotrophs. Photosynthesis maintains atmospheric oxygen levels and supplies most of the energy necessary for all life on Earth, except for chemotrophs, which gain energy through oxidative chemical reactions.

Although photosynthesis is performed differently by different species, the process always begins when energy from light is absorbed by proteins called reaction centres that contain green chlorophyll pigments. In plants, these proteins are held inside organelles called chloroplasts, which are most abundant in leaf cells, while in bacteria they are embedded in the plasma membrane. In these light-dependent reactions, some energy is used to strip electrons from suitable substances such as water. This produces oxygen gas and hydrogen ions, which are transferred to a compound called nicotinamide adenine dinucleotide phosphate (NADP+), reducing it to NADPH. More light energy is transferred to chemical energy in the generation of adenosine triphosphate (ATP), the “energy currency” of cells.

There are three fundamental dimensions of light: light duration, light quantity and light quality. Light duration is the photoperiod, or the number of continuous hours of light in each 24-hour period. Photoperiod regulates flowering in many greenhouse crops, and is simply concerned with the number of light hours and the number of darkness hours each day.

Light quantity is the number of light particles (called photons) capable of performing photosynthesis. Light quantity is more complex because it can be measured in two ways: the instantaneous amount of light (light intensity) and the cumulative amount of light delivered each day (daily light integral). Light quantity can be measured in different units, including foot-candles, lux, Watts, μmol·m⁻²·s⁻¹ and mol·m⁻²·d⁻¹. The latter two units are preferred when growing plants because they quantify the capacity of plants to perform photosynthesis (on an instantaneous and daily basis, respectively).

Light particles have different amounts of energy. The amount of energy of each light particle is determined by its wavelength. The relative number of light particles at each wavelength describes the third dimension of light, light quality. In other words, light quality refers to the spectral distribution of light, or the relative number of photons of blue, green, red, far red and other portions of the light spectrum emitted from a light source. Some of these portions are visible whereas others are not.

Plants respond to the relative lengths to light and dark periods as well as to the intensity and quality of light. Artificial light has been used extensively to control plant growth processes under various conditions. Plants differ in the need for light; some thrive on sunshine, others grow best in the shade. Most plants will grow in either natural or artificial light. Artificial light can be used in the following ways: to provide high intensity light when increased plant growth is desired, to extend the hours of natural daylight or to provide a night interruption to maintain the plants on long-day conditions.

Light is a source of energy and information for plants. It's needed as energy in photosynthesis and it provides plants critical information about its environment, which the plant needs in order to germinate, grow to a certain size or shape, induce protective substances, flower and when to change from vegetative growth. Plants react to quality, intensity, duration and the direction of light.

In addition to the light visible to humans (380 nm˜780 nm) plants use other radiation too. The 400 nm˜700 nm wavelength range is called “Photosynthetic Active Radiation” or PAR. Much of the light that plants need is in this range, but for optimal growth result, UV lights (280 nm˜400 nm) and/or far-red light (700 nm˜800 nm) might be important. For example, far-red is critical for the flowering of many plants. All light is not equal to plants, i.e., some areas are more important than others.

A grow light or plant light is an artificial light source, generally an electric light, designed to stimulate plant growth by emitting an electromagnetic spectrum appropriate for photosynthesis. Grow lights are used in applications where there is either no naturally occurring light, or where supplemental light is required. For example, in the winter months when the available hours of daylight may be insufficient for the desired plant growth, grow lights are used to extend the amount of time the plants receive light.

The growth and development of plants are not only controlled by light intensity, but also controlled by light quantity; the illumination time is also influencing. The controlling process of plants growth and development by light is very complicated. Plants use visible light for photosynthesis, infrared light, in particular 700˜800 nm for controlling morphogenesis, while the UV light can be absorbed by protein and causes damage. These reactions are through three main receptor systems. Chlorophyll a and b receive light wavelengths of 640 nm and 660 nm respectively to process the photosynthesis; Phytochrome receives light wavelengths of 660 and 730 nm to control many morphogenetic reactions; and flavin receives light wavelengths of 450 nm to induce tropism and high-energy photomorphogenesis.

### BRIEF DESCRIPTION OF THE DRAWINGS

FIG. 1 shows the embodiment of the present invention.

FIG. 2 shows the change of the spectrum after the light passing through the blue light transmissive material.

FIG. 3 shows the change of the spectrum after the light passing through the green light transmissive material.

FIG. 4 shows the change of the spectrum after the light passing through the light transmissive material of the present invention (A, B) and the changes before and after the light transmissive material of the present invention is placed (C).

FIG. 5 shows the block diagram of the apparatus for computing cumulative light quantity of the present invention.

FIG. 6 shows the practicing flowchart of the method for computing cumulative light quantity of the present invention.

FIG. 7 shows the light quantity data of the full band presented in the apparatus for computing cumulative light quantity of the present invention.

FIG. 8 shows the light quantity data of 400 nm˜450 nm spectrum wavelengths presented in the apparatus for computing cumulative light quantity of the present invention.

FIG. 9 shows the cumulative light quantity data of 400 nm˜450 nm spectrum wavelengths with time presented in the apparatus for computing cumulative light quantity of the present invention.

FIG. 10 shows the light quantity data of different bands shown in the apparatus for computing cumulative light quantity of the present invention.

### SUMMARY OF THE INVENTION

The present invention provides a method for stimulating plant growth. The present invention also provides an apparatus and methods for computing cumulative light quantity.

### DETAIL DESCRIPTION OF THE INVENTION

### Definitions

Unless otherwise specified, “a” or “an” means “one or more”.

Grow lights either attempt to provide a light spectrum similar to that of the sun, or to provide a spectrum that is more tailored to the needs of the plants being cultivated. Outdoor conditions are mimicked with varying color temperatures and spectral outputs from the grow light, as well as varying the lumen output (intensity) of the lamps. Depending on the type of plant being cultivated, the stage of cultivation (e.g., the germination/vegetative phase or the flowering/fruiting phase), and the photoperiod required by the plants, specific ranges of spectrum, luminous efficacy and color temperature are desirable for use with specific plants and time periods.

To develop the lamps suitable for plants growth is always the efforts worked in this filed. In the present invention, the applicant disclosed a simple method for stimulating plant growth.

Plants can sense light direction, quality (wavelength), intensity and periodicity. Light induces phototropism, photomorphogenesis, chloroplast differentiation and various other responses such as flowering and germination. Light quality is mainly sensed by the presence of different light receptors specific for different wavelengths. The red/far red photoreceptors are called phytochrome. There are at least 2 classes of blue light receptors; cryptochrome recognizes blue, green and UV-A light, while phototropin perceives blue light.

The relationship between the light quality and plant development was shown in “Photo morphogenesis in Plant” of G. H. M. Kronenberg (1986, Martinus Nijhoff Publishers). The impacts of different spectrum ranges on plant physiology were shown in Table 1.

TABLE 1
The impacts of different spectrum ranges on plant physiology

| spectrum ranges | | The effects on plant physiology |
|---|---|---|
| 280~315 | nm | Having the minimal impacts on the morphological and |
| | | physiological processes |
| 315~400 | nm | Chlorophyll absorbs less, having the impacts on the |
| | | photoperiod effect and prevents stems elongation |
| 400~520 | nm | Chlorophyll and carotenoids have the largest absorbing |
| | | proportion, having the greatest impacts on |
| | | photosynthesis |
| 520~610 | nm | The absorption rate is not high for the pigments |
| 610~720 | nm | The absorption rate is low for Chlorophyll, |
| | | having significant impact on photosynthesis |
| | | and photoperiod effects |
| 720~1000 | nm | The absorption rate is low, stimulating cells |
| | | elongation, affecting flowering and seed germination |
| 1000 | nm | Converting into heat |

It is generally thought that the colors of light have different impacts on photosynthesis. In fact, the effeteness of the colors of light has no difference in photosynthesis. Using full spectrum of light is the most beneficial for plant development (Harry Stijger, Flower Tech, 2004 7 (2)). The plants have the maximum sensitive spectrum region for light at 400˜700 nm, this section is generally referred to as photosynthetic active radiation region. About 45% of the sun's energy is in this region, so the light spectrum distribution for the plant growth should near this region.

The photon energy emitted by light is different due to different wavelengths. For example, the energy for wavelength of 400 nm (blue light) is 1.75 times than that for wavelength of 700 nm (red light). But for photosynthesis, the impacts of the two wavelengths are the same, the excess energy of the blue spectrum that cannot be used for photosynthesis transfers into heat. In other words, the rate of photosynthesis is determined by the photon number in 400˜700 nm that can be absorbed for the plant and is not related to the photon number from each spectrum. The plants have different sensitivities for all spectrums; it is because of the special absorbent of the pigments in leaves. Chlorophyll is the most common pigment in plants, but it is not the only useful pigment for photosynthesis, other pigments also participate in photosynthesis. Hence, for considering the efficiency of photosynthesis, the absorption spectrum of Chlorophyll is not the only thing to concern. For the morphogenesis and leafs color of plants, plants should receive a balanced variety of light. Blue light (400˜500 nm) is very important for plant differentiation and stomatal regulation. If the blue light is insufficient and the ratio of the far-red light is excess, the stems will being overgrowth and likely to cause leaf yellowing. When the ratio of red spectrum (655˜665 nm) and far-red (725˜735 nm) is between 1.0 and 1.2, the plants grow normally, but the sensitivities for spectrum ratio for different plant are different.

The present invention is related to a method for stimulating plant growth, which comprises:
(a) placing a light transmissive material for adjusting or retaining light spectrum wavelengths below 500 nm (section A), between 500˜630 nm (section B), and above 630 nm (section C) between the light and a photosynthesis receptor of the plant; and
(b) providing the illuminance or photon flux density of section B lower than that of section A or section C after the light passing through the light transmissive material.

The illuminance is the luminous flux received per unit area, which is measured in Lux (1 m/m²); the photon flux density is the number of photon reaching a surface per unit area in a unit of time, which is measured in μmol/m² sec. After the light passing through the transmissive material of the present invention, because of the adjusted or retained proportion of different spectrum wavelength is different, there are two peaks on section A and section C and the proportion of section B is lower than that of section A and section C.

The photosynthesis receptor of the present invention is chlorophyll a, chlorophyll b or carotenoids and the light is natural light or sun light.

The method of the present invention further adjusts distance between the light transmissive material and the plant to control growth efficiency which is calibrated by optimal reacting temperature, humidity, wind speed and luminosity of the photosynthesis receptor of the plant.

The method of the present invention controls color and ratio of each color of the light transmissive material to adjust or retain the light spectrum wavelengths. The light transmissive material is but not limited to fabrics, weaving net, gauze, woven fabrics, plastic fabrics, plastic paper, thermal insulation paper non-woven fabrics, staple fiber, peeling film, plastic board, thermoplastic polymer or molded articles. In a preferred embodiment, the light transmissive material is plastic fabrics or weaving net. The color of the light transmissive material is but not limited to dark blue, royal blue, blue, red-purple or dark purple.

In the present invention, different colors of the light transmissive materials are used to adjust the optimal ratio of light needed for specific stage based on the different light characteristics needed for the plant in each stage and shortens growth period of the plant. The method of the present invention is applied to natural environment or an artificial environment (includes but not limited to greenhouse).

Controlled-environment agriculture (CEA) is any agricultural technology that enables the grower to manipulate a crop's environment to the desired conditions. CEA technologies include greenhouse, hydroponics, aquaculture, and aquaponics, controlled variables include temperature, humidity, pH, and nutrient analysis.

The most suitable spectrum wavelengths range required by different plants is not well-known today. It is probably because of the differences in plant types and the amount of different spectrum wavelengths needed for plants is also dependent on the plant types. The goal of controlled-environment agriculture is to understand the effects of the environment and the key factors for plant growth, thereby from regulating these factors, one can increase the productivity, shorten the production process and improve the quality of plants. Therefore, the spectrum wavelength and exposure amount needed for plants should be understood first.

The present invention also provides an apparatus for computing cumulative light quantity, comprising:
(a) a spectrum sensing unit, for measuring light quantity data in a spectrum wavelengths range;
(b) a spectrum multi-band setting module, being connected to the spectrum sensing unit, for setting wavelengths of a full band or multi-bands in the spectrum wavelengths range with respect to the spectrum sensing unit;
(c) a cumulative light quantity computing module, being connected to the spectrum sensing unit, for cumulatively computing the light quantity data measured by the spectrum sensing unit into cumulative light quantity data;
(d) an information processing unit, being connected to the cumulative light quantity computing module, for processing, recording and storing the cumulative light quantity data; and
(e) a control unit, being connected to the spectrum multi-band setting module and the information processing unit, for controlling setting of the spectrum multi-band setting module and the information processing unit.

The apparatus of the present invention further comprises a monitor, being connected to the information processing unit for displaying the recorded cumulative light quantity data.

In the apparatus of the present invention, the spectrum wavelengths range is in full spectrum, 360 nm˜830 nm or 400 nm˜700 nm and unit of the light quantity data is lux, μmol/m²/s or W/m².

In the preferred embodiment of the apparatus of the present invention, the spectrum sensing unit is a spectrometer and the spectrum multi-band setting module in overlap sets spectrum ranges in different bands.

The present invention further provides a method for computing cumulative light quantity, comprising:
(a) providing a spectrum sensing unit for measuring light quantity data in a spectrum wavelengths range;
(b) providing a control unit for controlling setting of a spectrum multi-band setting module and an information processing unit;
(c) setting wavelengths of a full band or multi-bands in the spectrum wavelengths range with respect to the spectrum sensing unit through the spectrum multi-band setting module;
(d) providing a cumulative light quantity data computing module for cumulatively computing the light quantity data measured by the spectrum sensing unit into cumulative light quantity data; and
(e) processing, recording and storing the cumulative light quantity data through the information processing unit.

The method of the present invention, further comprises a monitor, for displaying the recorded cumulative light quantity data.

In the method of the present invention, the spectrum sensing unit can simultaneously measure all light quantity data in the spectrum wavelengths range.

In the method of the present invention, the spectrum wavelengths range is in full spectrum, 360 nm˜830 nm or 400 nm˜700 nm and unit of the light quantity data is lux, μmol/m²/s or W/m².

In the preferred embodiment of the method of the present invention, the spectrum sensing unit is a spectrometer and the spectrum multi-band setting module in overlap sets spectrum ranges in different bands

### EXAMPLES

The examples below are non-limiting and are merely representative of various aspects and features of the present invention.

In the present invention, the sun or placed LED lamp or T5 fluorescent lamp was used as the light source. For the spectrum wavelengths above 500 nm, below 630 nm or the intersection of the above two were filtered to increase the proportion of the light quantity of spectrum wavelengths below 500 nm and above 630 nm and to promote the photosynthesis efficiency, shortens the growth period to 90%-70% of the original.

### Example 1

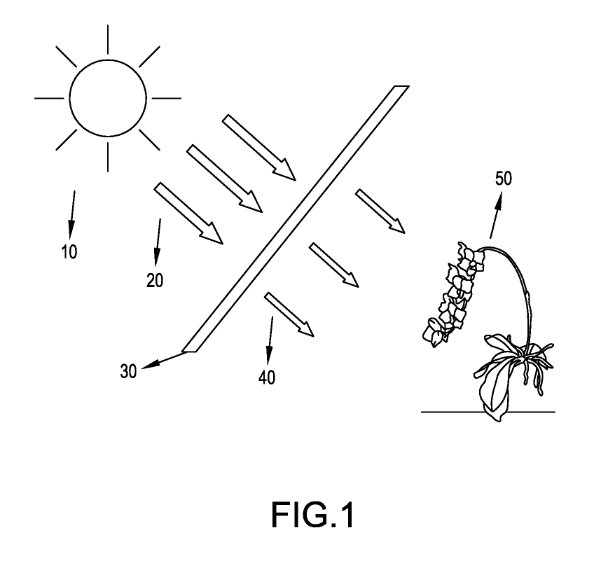

As shown in FIG. 1, LED light source 10 was put in front of the leaf of the plant or other photosynthesis receptor and illuminated to the plant. The light that did not pass through the light transmissive material 20 was filtered by the royal blue, blue or dark blue light transmissive material 30 of plastic fabrics or woven net. The light that passed through the light transmissive material 40 and illuminated to the plant 50 was adjusted or retained for the proper spectrum to promote the plant growth.

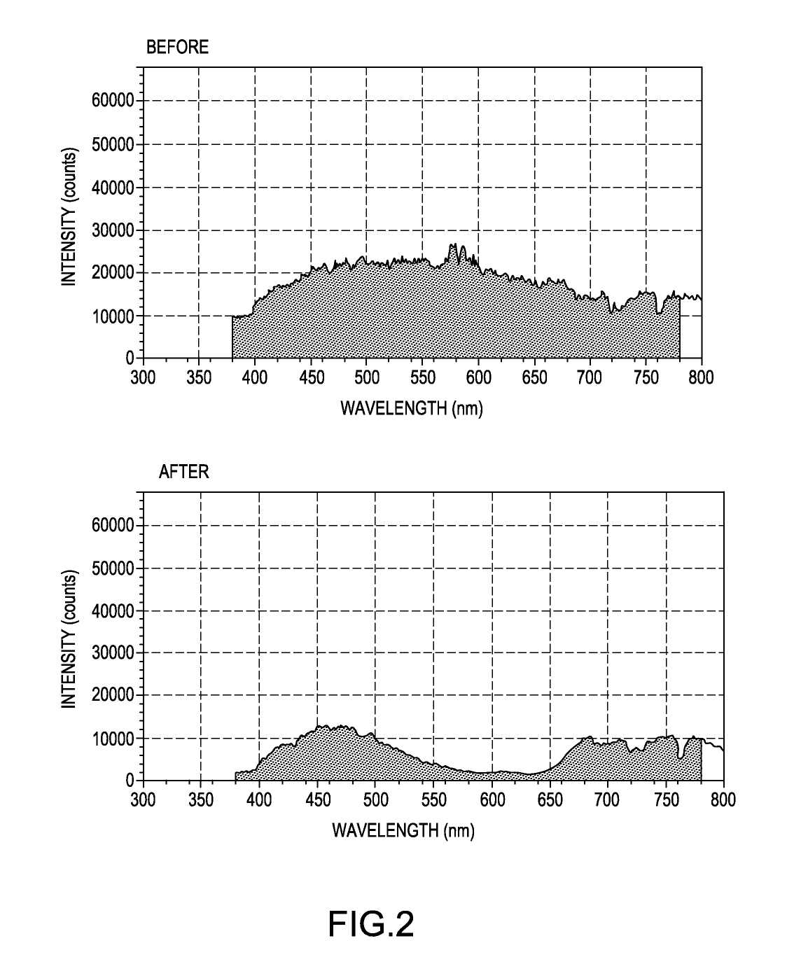

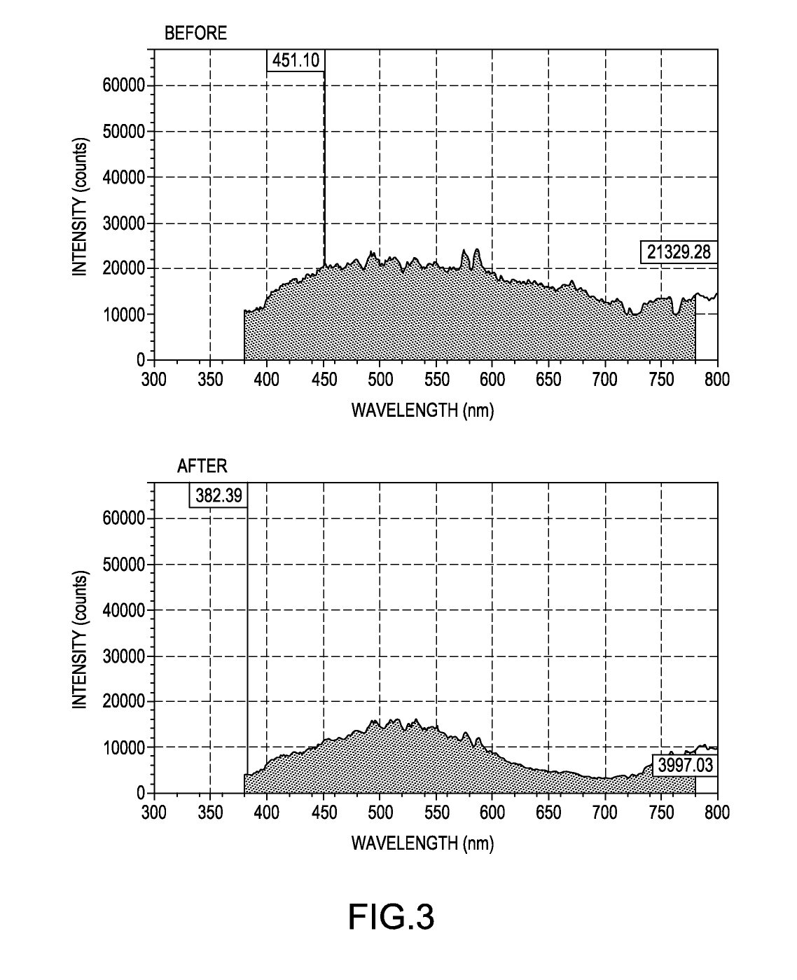

After the light passed through the blue and green light transmissive material, the changes of the spectrum were shown in FIG. 2 and FIG. 3. There were two peaks after the light passed through the blue light transmissive material.

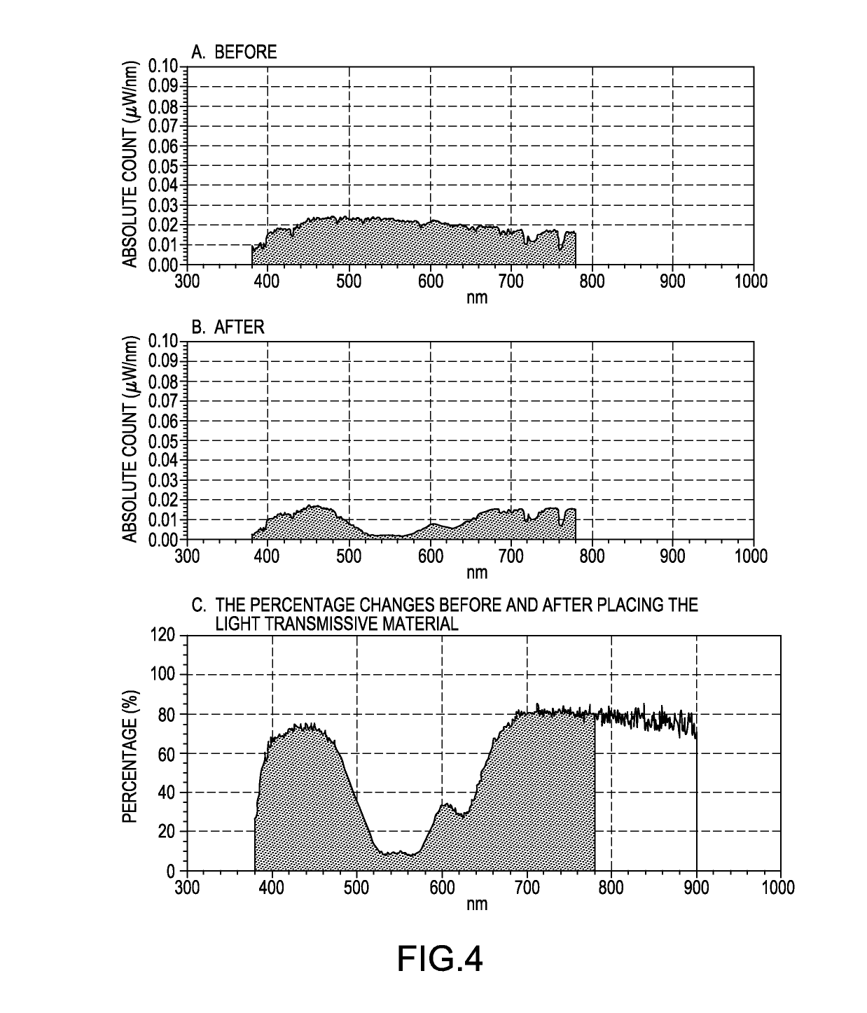

In the preferred embodiment, after the light passed through the light transmissive material of the present invention, the adjusted or retained proportions of different spectrum wavelength were different. After placing the light transmissive material of the present invention, there were two peaks on section A and section C (FIG. 4B). From the different spectrum percentage before and after placing the light transmissive material, the proportion of section B was lower than that of section A and section C (FIG. 4C).

### Example 2

Phalaenopsis seedlings were placed under a normal black weaving net; the light quantity they received was proportionally reduced of all spectrum wavelengths. The other groups of Phalaenopsis seedlings were placed under the royal blue plastic fabrics or woven net of the present invention to receive the adjusted or retained light from the light transmissive material. As the results, the growth period of the seedlings placed under the black weaving net was 16 weeks; the growth period of the seedlings placed under the royal blue plastic fabrics or woven net of the present invention was 1-2 weeks shorter. The acclimatization period of the Phalaenopsis placed under the royal blue plastic fabrics or woven net of the present invention was also 1-2 weeks shorter than that of placing under the black weaving net.

### Example 3

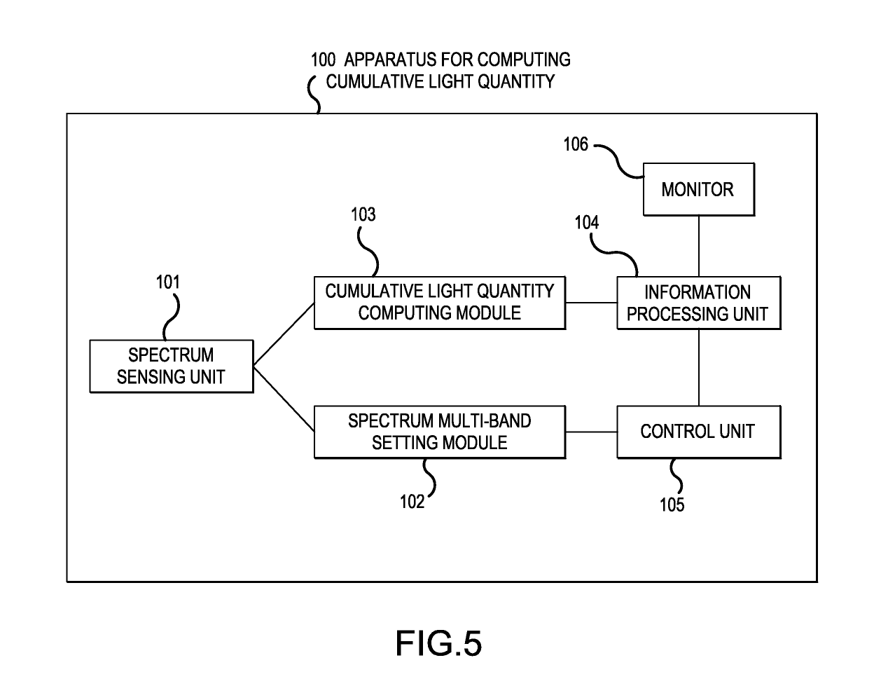

One embodiment of the apparatus for computing cumulative light quantity 100 is shown in FIG. 5, which comprises: a spectrum sensing unit 101, for measuring light quantity data in a spectrum wavelengths range; a spectrum multi-band setting module 102, being connected to the spectrum sensing unit 101, for setting wavelengths of a full band or multi-bands in the spectrum wavelengths range with respect to the spectrum sensing unit 101; a cumulative light quantity computing module 103, being connected to the spectrum sensing unit 101, for cumulatively computing the light quantity data measured by the spectrum sensing unit 101 into cumulative light quantity data; an information processing unit 104, being connected to the cumulative light quantity computing module 103, for processing, recording and storing the cumulative light quantity data; a control unit 105, being connected to the spectrum multi-band setting module 102 and the information processing unit 104, for controlling setting of the spectrum multi-band setting module 102 and the information processing unit 104; and a monitor 106, being connected to the information processing unit 104 for displaying the recorded cumulative light quantity data.

### Example 4

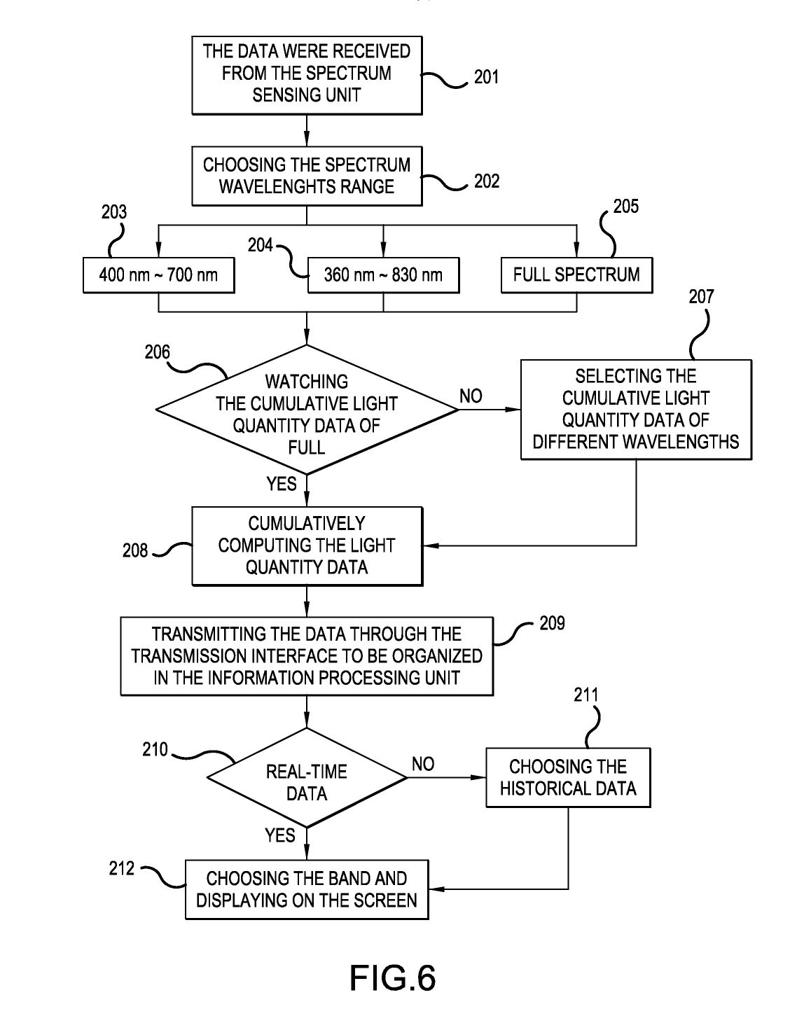

FIG. 6 showed the practicing flowchart of the method for computing cumulative light quantity of the present invention. Through the apparatus for computing cumulative light quantity of the present invention, the data were received from the spectrum sensing unit and choosing the spectrum wavelengths range of 400 nm˜700 nm, 360 nm˜830 nm or full spectrum via the control unit. Then selected watching the cumulative light quantity data of full band or wavelengths ranges (for example, 400 nm˜450 nm, 430 nm˜460 nm, 470 nm˜500 nm, etc.) of different bands. Cumulatively computed the light quantity data by the cumulative light quantity computing module and transmitted the data through the transmission interface to be organized in the information processing unit. At this point, real-time data or historical data can be chosen and the chosen band was displayed on the screen.

### Example 5

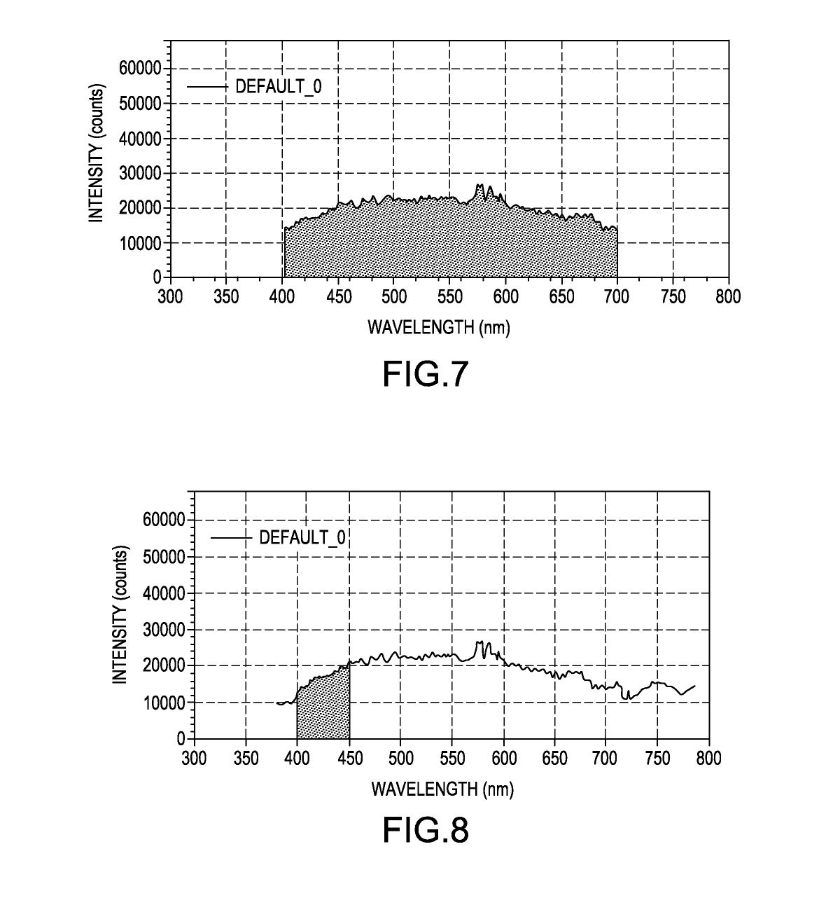

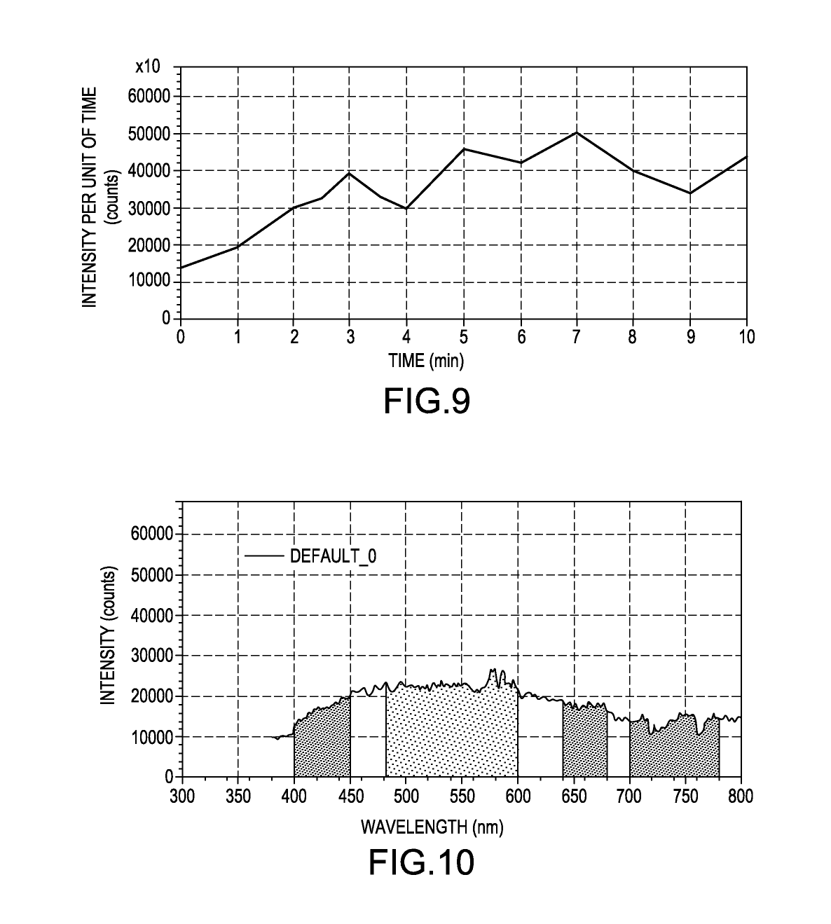

Based on the above mentioned apparatus and process, the embodiments of the apparatus and method for computing cumulative light quantity of the present invention were shown as follows: the light quantity data of the full band presented in the apparatus for computing cumulative light quantity of the present invention was shown in FIG. 7; the light quantity data of 400 nm˜450 nm spectrum wavelengths presented in the apparatus for computing cumulative light quantity of the present invention was shown in FIG. 8. FIG. 9 was cumulatively computed with time by the light quantity data of 400 nm˜450 nm spectrum wavelengths of FIG. 8. The cumulative light quantity intensity of 400 nm˜450 nm spectrum wavelengths was computed by the area below the line of FIG. 9. FIG. 10 showed the light quantity data of different bands (e.g., 400 nm˜450 nm, 470 nm˜500 nm, etc.) presented in the apparatus for computing cumulative light quantity of the present invention. The light quantity data of each band also can be computed to cumulative light quantity data with time as shown in FIG. 9 and the wavelengths range of each band can be set in overlap.

While the invention has been described and exemplified in sufficient detail for those skilled in this art to make and use it, various alternatives, modifications, and improvements should be apparent without departing from the spirit and scope of the invention.

One skilled in the art readily appreciates that the present invention is well adapted to carry out the objects and obtain the ends and advantages mentioned, as well as those inherent therein. The apparatus, processes and methods for producing them are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

What is claimed is:

1. A method for stimulating plant growth, which comprises:
(a) placing a light transmissive material for adjusting or retaining light spectrum wavelengths below 500 nm (section A), between 500˜630 nm (section B), and above 630 nm (section C) between the light and a photosynthesis receptor of the plant; and
(b) providing the illuminance or photon flux density of section B lower than that of section A or section C after the light passing through the light transmissive material.

2. The method of claim 1, wherein the photosynthesis receptor is chlorophyll a, chlorophyll b or carotenoids.

3. The method of claim 1, wherein the light is natural light.

4. The method of claim 1, which further adjusts distance between the light transmissive material and the plant to control growth efficiency.

5. The method of claim 4, wherein the distance between the light transmissive material and the plant is calibrated by optimal reacting temperature, humidity, wind speed and luminosity of the photosynthesis receptor of the plant.

6. The method of claim 1, which controls color and ratio of each color of the light transmissive material to adjust or retain the light spectrum wavelengths.

7. The method of claim 1, which shortens growth period of the plant.

8. The method of claim 1, wherein the light transmissive material is fabrics, weaving net, gauze, woven fabrics, plastic fabrics, plastic paper, thermal insulation paper or non-woven fabrics.

9. The method of claim 8, wherein the light transmissive material is plastic fabrics or weaving net.

10. The method of claim 1, wherein the light transmissive material is staple fiber, peeling film, plastic board, thermoplastic polymer or molded articles.

11. The method of claim 1, which is applied to natural environment or a greenhouse.

12. An apparatus for computing cumulative light quantity, comprising:
(a) a spectrum sensing unit, for measuring light quantity data in a spectrum wavelengths range;
(b) a spectrum multi-band setting module, being connected to the spectrum sensing unit, for setting wavelengths of a full band or multi-bands in the spectrum wavelengths range with respect to the spectrum sensing unit;
(c) a cumulative light quantity computing module, being connected to the spectrum sensing unit, for cumulatively computing the light quantity data measured by the spectrum sensing unit into cumulative light quantity data;
(d) an information processing unit, being connected to the cumulative light quantity computing module, for processing, recording and storing the cumulative light quantity data; and
(e) a control unit, being connected to the spectrum multi-band setting module and the information processing unit, for controlling setting of the spectrum multi-band setting module and the information processing unit.
wherein unit of the light quantity data is lux, μmol/m2/s or W/m2.

13. The apparatus of claim 12, further comprises a monitor, being connected to the information processing unit for displaying the recorded cumulative light quantity data.

14. The apparatus of claim 12, wherein the spectrum wavelengths range is in full spectrum, 360 nm˜830 nm or 400 nm˜700 nm.

15. The apparatus of claim 12, wherein the spectrum sensing unit is a spectrometer.

16. The apparatus of claim 12, wherein the spectrum multi-band setting module in overlap sets spectrum ranges in different bands.

17. A method for computing cumulative light quantity, comprising:
(a) providing a spectrum sensing unit for measuring light quantity data in a spectrum wavelengths range;
(b) providing a control unit for controlling setting of a spectrum multi-band setting module and an information processing unit;
(c) setting wavelengths of a full band or multi-bands in the spectrum wavelengths range with respect to the spectrum sensing unit through the spectrum multi-band setting module;
(d) providing a cumulative light quantity data computing module for cumulatively computing the light quantity data measured by the spectrum sensing unit into cumulative light quantity data; and
(e) processing, recording and storing the cumulative light quantity data through the information processing unit.
wherein unit of the light quantity data is lux, μmol/m²/s or W/m².

18. The method of claim 17, wherein the spectrum wavelengths range is in full spectrum, 360 nm˜830 nm or 400 nm˜700 nm.

19. The method of claim 17, wherein the spectrum multi-band setting module in overlap sets spectrum ranges in different bands.

20. (canceled)
